(19) United States
(12) Patent Application Publication
(10) Pub. No.: US 2025/0184079 A1
(43) Pub. Date: Jun. 5, 2025

(54) METHOD AND APPARATUS FOR A DYNAMIC SPECTRUM SHARING IN A WIRELESS COMMUNICATION SYSTEM

(71) Applicant: SAMSUNG ELECTRONICS CO., LTD., Suwon-si (KR)

(72) Inventors: Davydov ALEXEI, Saratov (RU); Denis ESIUNIN, Saratov (RU); Ermolaev GREGORY, Saratov (RU); Pestretsov VLADIMIR, Saratov (RU); Dikarev DMITRY, Saratov (RU); Morozov GREGORY, Saratov (RU)

(21) Appl. No.: 18/964,081

(22) Filed: Nov. 29, 2024

(30) Foreign Application Priority Data
Dec. 1, 2023 (RU) 2023131586

(51) Int. Cl. H04L 5/00; H04B 7/06; H04J 13/00; H04L 27/26

(52) U.S. Cl. CPC H04L 5/0051; H04B 7/0626; H04J 13/0062; H04L 27/2605

(57) ABSTRACT

The disclosure relates to a 5G or 6G communication system for supporting a higher data transmission rate.

### CROSS-REFERENCE TO RELATED APPLICATION

This application is based on and claims priority under 35 U.S.C. § 119 to Russian Patent Application No. 2023131586 filed on Dec. 1, 2023, in the Russian Intellectual Property Office, the disclosure of which is incorporated by reference herein in its entirety.

### BACKGROUND

### 1. Field

The present disclosure relates to communication methods and devices implementing the same, namely to a transmit-receive point (TRP) and a user equipment (UE), which ensure sharing of reference signals sequence to implement improved dynamic spectrum sharing.

### 2. Description of Related Art

6^{th} generation (6G) communication systems are expected to be deployed in new bands (e.g., sub-THz) as well as available bands (e.g., mid-band) currently used by other radio access technologies such as 4G, 5G. Traditionally, two approaches are considered for deploying new radio access technology (for example, 6G) in available frequency bands: step-by-step spectrum refarming (switching certain frequency subbands of the operating frequency band) from supporting one radio access technology to supporting another radio access technology as users migrate from the one radio access technology to other one, and dynamic spectrum sharing (DSS) that dynamically redistributes spectrum between radio access technologies depending on a number of their currently active users.

Spectrum refarming to support a new radio access technology is beneficial in terms of the technology's performance provided in this case, but may have a negative impact on the performance of existing radio access technologies. DSS provides a more dynamic and flexible sharing of resources between radio access technologies, however it can have a negative impact due to additional scheduling limitations and additional overhead due to the need to transmit reference signals for each radio access technology supported in the network (see in FIG. 1 the central area related to DSS).

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network.

In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

The present disclosure relates to the field of communication. A Transmit-receive point implemented method of transmitting reference signals, the method includes: generating a first set of reference signals according to a first radio access technology, generating a second set of reference signals according to a second radio access technology, and performing downlink transmission of the first set of reference signals and the second set of reference signals, wherein, when generating the first set of reference signals or the second set of reference signals, at least one reference signal is generated and used as at least one common reference signal used by both the first radio access technology and the second radio access technology.

It is an object of the present disclosure to provide communication methods and communication devices that ensure improved DSS by at least partially sharing the reference signal sequences of radio access technologies supported in the network (see in FIG. 2 the central area related to DSS). Such partial sharing of the reference signal sequences of radio access technologies supported in the network reduces overhead and, as a result, increases communication performance.

According to embodiments of the present disclosure, a method performed by a base station in a wireless communication system is provided, the method comprises: identifying at least one reference signal associated with a first radio access technology (RAT); identifying at least one reference signal associated with a second RAT; generating at least one common reference signal; and transmitting, to a terminal, the at least one common reference signal, wherein the at least one common reference signal is used by both the first RAT and the second RAT and is transmitted in a time-frequency resource shared by the first RAT and the second RAT.

Provided in a first aspect of the present disclosure is a Transmit-receive point (TRP) implemented method of transmitting reference signals, the method includes the steps of: generating a first set of reference signals according to a first radio access technology, generating a second set of reference signals according to a second radio access technology, and performing downlink transmission of the first set of reference signals and the second set of reference signals, wherein, when generating the first set of reference signals or the second set of reference signals, at least one reference signal is generated and used as at least one common reference signal used by both the first radio access technology and the second radio access technology.

According to the development of the first aspect of the present disclosure the at least one common reference signal is transmitted in a time-frequency resource shared by the first radio access technology and the second radio access technology.

According to the development of the first aspect of the present disclosure the at least one common reference signal is a primary synchronization signal (PSS) and/or a secondary synchronization signal (SSS).

According to the development of the first aspect of the present disclosure, when only the PSS is the common reference signal, transmission of the SSS of the first radio access technology and transmission of the SSS of the second radio access technology are performed on the same subcarriers but different orthogonal frequency-division multiplexing (OFDM) symbols, and transmission of the physical broadcast channel (PBCH) of the first radio access technology and transmission of the PBCH of the second radio access technology are carried out on non-overlapping subcarriers and/or non-overlapping OFDM symbols.

According to the development of the first aspect of the present disclosure, when only the SSS is the common reference signal, transmission of the PSS of the first radio access technology and transmission of the PSS of the second radio access technology are performed on the same subcarriers but different orthogonal frequency-division multiplexing (OFDM) symbols, and transmission of the physical broadcast channel (PBCH) of the first radio access technology and transmission of the PBCH of the second radio access technology are carried out on non-overlapping subcarriers and/or non-overlapping OFDM symbols.

According to the development of the first aspect of the present disclosure, when the PSS and the SSS are the common reference signals, transmission of the PBCH of the first radio access technology and transmission of the PBCH of the second radio access technology are carried out on non-overlapping subcarriers and/or non-overlapping OFDM symbols.

According to the development of the first aspect of the present disclosure, the method further includes, at the TRP, the steps of: transmitting in the system information (SI) of the first radio access technology a first value of a parameter, to be received at the UE side of the first radio access technology and applied to the Zadoff-Chu (ZC) sequence to generate the corresponding PRACH preamble to be transmitted to the TRP in a preconfigured time-frequency resource used for transmitting the reference signal of both the first radio access technology and the second radio access technology, and transmitting in the SI of the second radio access technology a second value of the parameter, to be received at the UE side of the second radio access technology and applied to the ZC sequence to generate the corresponding PRACH preamble to be transmitted to the TRP in the preconfigured time-frequency resource, wherein the first value of the parameter, applied for the first radio access technology, differs from the second value of the parameter, applied for the second radio access technology, said parameter is one or more of the following: a cyclic shift step with additional offset or without additional offset, which specifies a set of cyclic shifts applied to cyclically shift the ZC-sequence in time domain for generation, from that ZC-sequence, PRACH preambles, and, optionally, an initial cyclic shift of the set of cyclic shifts, specifying the cyclic shift to be applied as the initial cyclic shift, and/or a ZC sequence root index specifying the initial root of the ZC sequence from a set of sequence roots for generation of the PRACH preamble.

According to the development of the first aspect of the present disclosure the at least one transmitted common reference signal is a channel state information reference signal (CSI-RS).

According to the development of the first aspect of the present disclosure, CSI-RS is one or more of:—CSI-RS for channel state information (CSI) feedback;—CSI-RS for beam management; and/or CSI-RS for tracking.

According to the development of the first aspect of the present disclosure the first radio access technology is 5G and the second radio access technology is 6G, or the first radio access technology is 6G and the second radio access technology is 5G.

According to the development of the first aspect of the present disclosure generation and transmission of reference signals and/or use of a single time-frequency resource for transmitting PRACH preambles of different radio access technologies is performed to provide DSS in a specific operating frequency band in which concurrent operation of both the first radio access technology and the second radio access technology is supported.

Provided in a second aspect of the present disclosure is a Transmit-receive point comprising a transmitting-receiving antenna unit and a processor configured to perform the method according to the first aspect of the present disclosure or according to any development of the first aspect of the present disclosure.

Provided in a third aspect of the present disclosure is a storage medium storing processor executable instructions, which, when executed by the processor of a device equipped with a transmitting-receiving antenna unit, ensure the performance of the method according to the first aspect of the present disclosure or according to any development of the first aspect of the present disclosure.

Provided in a fourth aspect of the present disclosure is a User equipment (UE) implemented method of communication with a Transmit-receive point (TRP), the method including the steps of: receiving reference signals, including at least one common reference signal used by both a radio access technology supported by the UE and another radio access technology, performing uplink transmission to the TRP, the transmission being configured based at least in part on the received reference signals, including based on the common reference signal.

According to a development of the fourth aspect of the present disclosure the one common reference signal is received in a time-frequency resource common for the first radio access technology and the second radio access technology.

According to the development of the fourth aspect of the present disclosure the at least one common reference signal is a primary synchronization signal (PSS) and/or a secondary synchronization signal (SSS).

According to the development of the fourth aspect of the present disclosure, when only the PSS is the common reference signal, the frequency resources used to receive the SSS of the supported radio access technology are the same as the frequency resources on which the SSS of said other radio access technology is transmitted, and the time resources used to receive the SSS of the supported radio access technology are different from the time resources on which the SSS of said other radio access technology is transmitted, and the time-frequency resources used to receive the PBCH of the supported radio access technology are at least partially different from the time-frequency resources on which the PBCH of the other radio access technology is transmitted.

According to the development of the fourth aspect of the present disclosure, when only the SSS is the common reference signal, the frequency resources used to receive the PSS of the supported radio access technology are the same as the frequency resources on which the PSS of said other radio access technology is transmitted, and the time resources used to receive the PSS of the supported radio access technology are different from the time resources on which the PSS of said other radio access technology is transmitted, and the time-frequency resources used to receive the PBCH of the supported radio access technology are at least partially different from the time-frequency resources on which the PBCH of the other radio access technology is transmitted.

According to the development of the fourth aspect of the present disclosure, when the PSS and the SSS are the common reference signals, the time-frequency resources used to receive the PBCH of the supported radio access technology are at least partially different from the time-frequency resources on which the PBCH of the other radio access technology is transmitted.

According to the development of the fourth aspect of the present disclosure, the method further includes, at the UE, the steps of: receiving in the system information (SI) of the supported radio access technology a value of a parameter, to be applied to the Zadoff-Chu (ZC) sequence to generate the PRACH preamble to be transmitted to the TRP in a preconfigured time-frequency resource used for transmitting the reference signal of both the supported radio access technology and the other radio access technology, generating the PRACH preamble using the received value of the parameter, and transmitting the generated PRACH preamble to the TRP in the preconfigured time-frequency resource, wherein the value of the parameter, applied for the supported radio access technology, differs from a value of the parameter, applied for the other radio access technology, wherein said parameter is one or more of the following parameters: a cyclic shift step with additional offset or without additional offset, which specifies a set of cyclic shifts applied to cyclically shift the ZC-sequence in time domain for generation, from that ZC-sequence, PRACH preambles, and, optionally, an initial cyclic shift of the set of cyclic shifts, specifying the cyclic shift to be applied as the initial cyclic shift, and/or a ZC sequence root index specifying the initial root of the ZC sequence from a set of sequence roots for generation of the PRACH preamble.

According to the development of the fourth aspect of the present disclosure the at least one received common reference signal is a channel state information reference signal (CSI-RS).

According to the development of the fourth aspect of the present disclosure, CSI-RS is one or more of:—CSI-RS for channel state information (CSI) feedback;—CSI-RS for beam management; and/or CSI-RS for tracking.

According to the development of the fourth aspect of the present disclosure the supported radio access technology is 5G and the other radio access technology is 6G, or the supported radio access technology is 6G and the other radio access technology is 5G.

Provided in a fifth aspect of the present disclosure is a user equipment comprising a transmitting-receiving antenna unit and a processor configured to perform the method according to the fourth aspect of the present disclosure or according to any development of the fourth aspect of the present disclosure.

Provided in a sixth aspect of the present disclosure is a storage medium storing processor executable instructions, which, when executed by the processor of a device equipped with a transmitting-receiving antenna unit, ensure the performance of the method according to the fourth aspect of the present disclosure or according to any development of the fourth aspect of the present disclosure.

Provided in a seventh aspect of the present disclosure is a communication system comprising one or more transmit-receive points according to the second aspect of the present disclosure or according to any development of the second aspect of the present disclosure, and one or more user equipment according to the fifth aspect of the present disclosure or according to any development of the fifth aspect of the present disclosure.

Provided in yet another aspect of the present disclosure is a transmit-receive point (TRP) implemented method of transmitting reference signals used by different radio access technologies in a pre-configured single time-frequency resource, the method comprising: transmitting in the system information (SI) of a first radio access technology a first value of a parameter, to be, at the UE of the first radio access technology, received and applied in generation of a first reference signal to be transmitted to the TRP in said single time-frequency resource, transmitting in the SI of a second radio access technology a second value of the parameter, to be, at the UE of the second radio access technology, received and applied in generation of a second reference signal to be transmitted to the TRP in said single time-frequency resource, wherein the first value of the parameter differs from the second value of the parameter.

According to the development of the yet another aspect of the present disclosure, application of different values of said parameter by user equipment using different radio access technologies provides sharing (i.e., orthogonality) of sequences of reference signals to be transmitted to the TRP in said single time-frequency resource.

According to the development of said yet another aspect of the present disclosure, said parameter is one or more of the following parameters: a cyclic shift step with additional offset or without additional offset, which specifies a set of cyclic shifts applied to cyclically shift the sequence in time domain for generation, from that sequence, of reference signals to be transmitted to the TRP by the UE of the corresponding radio access technology in said single time-frequency resource, and, optionally, an initial cyclic shift of the set of cyclic shifts, specifying the cyclic shift to be applied as the initial cyclic shift, and/or a sequence root index specifying the initial root of the sequence from a set of sequence roots, to be applied as the initial root of the sequence for generation of reference signals to be transmitted to the TRP by the UE in said single time-frequency resource.

According to the development of said yet another aspect of the present disclosure, the reference signal to be transmitted to the TRP by the UE of the corresponding radio access technology in said single time-frequency resource is the physical random access channel (PRACH) preamble, and said sequence is Zadoff-Chu (ZC) sequence.

According to the development of said yet another aspect of the present disclosure, the first radio access technology is 5G and the second radio access technology is 6G, or the first radio access technology is 6G and the other radio access technology is 5G.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

The implementation of the above-described aspects of the present disclosure and their developments will be described with references to the figures in which:

FIG. 1 illustrates a transition from one radio access technology (5G) to another radio access technology (6G) through an intermediate DSS stage according to various embodiments of the present disclosure;

FIG. 2 illustrates another transition from one radio access technology (5G) to another radio access technology (6G) through an intermediate DSS stage according to various embodiments of the present disclosure;

FIG. 3 illustrates a flowchart of a communication method of a TRP for transmitting reference signals to a UE according to various embodiments of the present disclosure;

FIG. 4 illustrates a flowchart of a communication method of UE for receiving from TRP reference signals according to various embodiments of the present disclosure;

FIG. 5A illustrates an SS/PBCH reference signal block structure with PSS and SSS reference signal sequences shared between 5G and 6G radio access technologies according to various embodiments of the present disclosure;

FIG. 5B illustrates an SS/PBCH reference signal block structure with PSS reference signal sequence shared between 5G and 6G radio access technologies according to various embodiments of the present disclosure;

FIG. 5C illustrates an SS/PBCH reference signal block structure with PSS reference signal sequence shared between 5G and 6G radio access technologies according to various embodiments of the present disclosure;

FIG. 6A illustrates PRACH preamble sequences sharing between 5G and 6G radio access technologies by applying different cyclic shift step values according to various embodiments of the present disclosure;

FIG. 6B illustrates PRACH preamble sequences sharing between 5G and 6G radio access technologies by applying different ZC-sequence root values according to various embodiments of the present disclosure;

FIG. 7 illustrates a TRP configured to perform a communication method according to various embodiments of the present disclosure;

FIG. 8 illustrates a UE configured to perform a communication method according to various embodiments of the present disclosure; and

FIG. 9 illustrates communication system according to various embodiments of the present disclosure.

### DETAILED DESCRIPTION

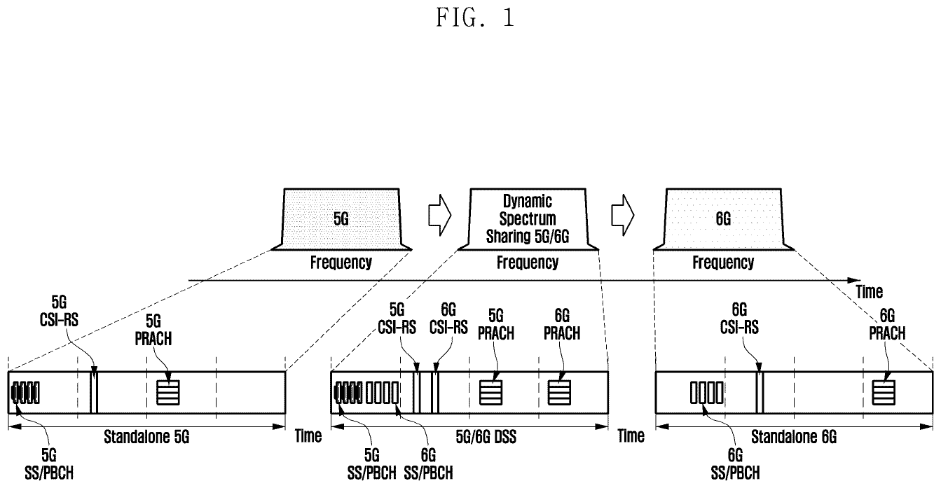

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

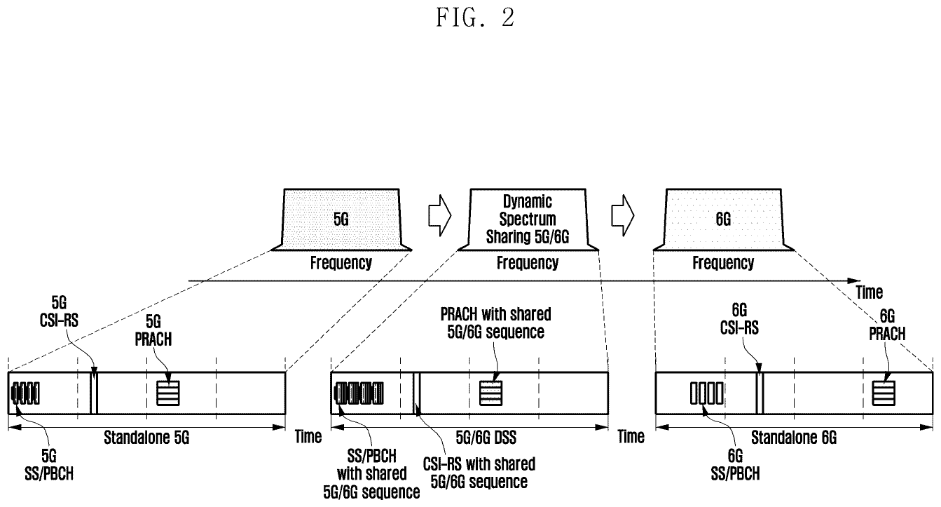

The present disclosure discloses communication methods and related devices that transmit/receive reference signals with partial sharing of sequences of such signals. This achieves reduced signal overhead and improved communication performance while supporting multiple radio access technologies. Basic reference signals are service signals to support basic communication between the TRP and the UE, which include, but are not limited to, reference signals of synchronization signal (SS)/physical broadcast channel (PBCH) block, CSI-RSs, and PRACH preambles. The general illustration of the DSS with a portion of one technology's reference signals being reused as a portion of another technology's reference signals according to the present disclosure is shown in the 5G/6G DSS area in FIG. 2.

To implement communication between TRP and UE with DSS between different radio access technologies, any available (operating) frequency range can be used, including the one currently used for 4G LTE, Pre-5G, 5G NR, etc. Non-limiting examples of the available frequency range may include Frequency Range 1 (FR1) up to 7.125 GHz or at least a portion thereof, frequency range 2 (FR2) from 24.25 GHz to 71 GHz or at least a portion thereof, or a frequency range from 7.125 GHz to 24.25 GHz or at least a portion thereof.

The SS/PBCH reference signal block used in 5G radio access technology and expected for being used in the next radio access technology (e.g., 6G) includes an SS containing PSS and SSS, and PBCH including demodulation reference signals (DMRSs). A periodic transmission of SS/PBCH block reference signals allows the UE to detect the presence of a cell and to synchronize with that cell and the TRP serving that cell based on information that can be detected and decoded by the UE from the contents of the SS/PBCH block. Such information may include, but is not limited to, the cell's physical identifier N_{ID}^{Cell}, system frame number (SFN), master information block (MIB), system information block (SIB), as well as other signals, including those based on which the UE may perform various cell measurements, such as, but not limited to, RSRP measurements, RSRQ measurements, etc.

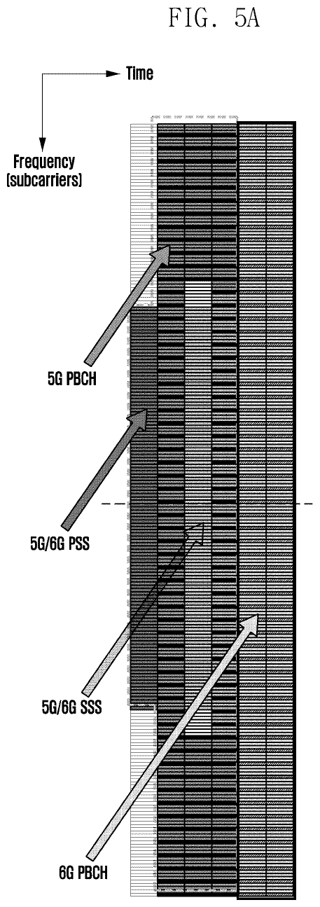

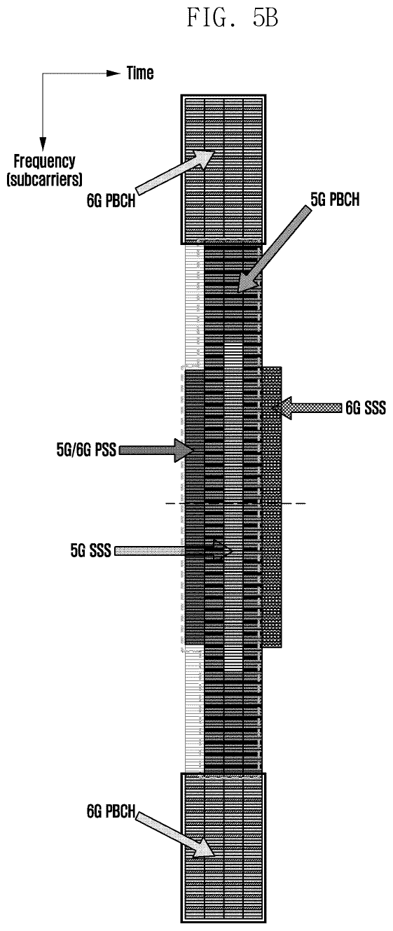

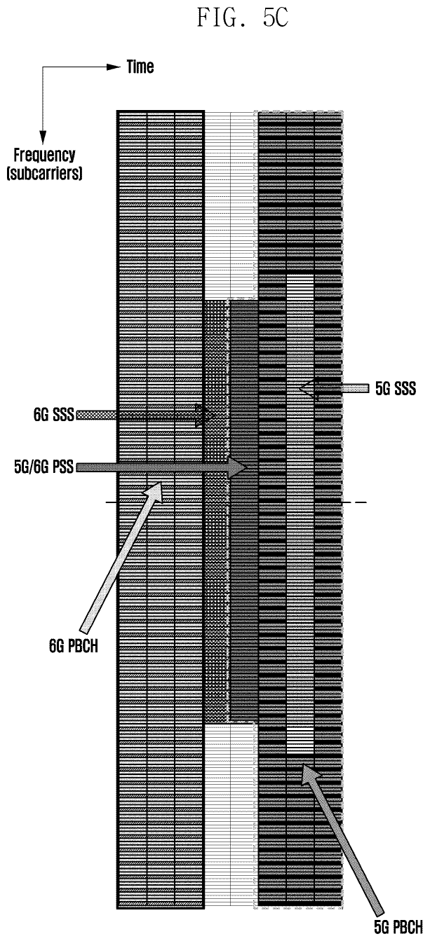

The entire SS/PBCH reference signal block typically occupies 240 subcarriers in the frequency domain and 4 OFDM symbols in the time domain. Each of the PSS and SSS is typically mapped to the 127 center subcarriers in the zero and second OFDM symbols, respectively. In the first and third OFDM symbols, the PBCH is typically mapped to all 240 subcarriers, in the second OFDM symbol the PBCH is typically mapped to the outermost 48 subcarriers on each side of the SSS. In the second OFDM symbol, guard intervals may be used between the SSS and the PBCH. In the present disclosure, provided and described in detail with reference to FIGS. 5A, 5B, and 5C are modified SS/PBCH reference signal block structures supporting reuse of a portion of the SS/PBCH reference signals of one radio access technology (e.g., 5G) as a portion of the corresponding SS/PBCH reference signals of another radio access technology (e.g., 6G). According to the present disclosure, the SS/PBCH signal may be generated to include common for different radio access technologies: PSS, SSS, or PSS and SSS, but in all cases these reference signals may be located in the frequency domain in the same way (for example, each time on the same 127 center subcarriers). Such mapping of PSS and/or SSS sequences onto frequency domain resources allows for a simplified configuration of the communication network with DSS, since the UE, regardless of the radio access technology used, may expect transmission of such shared reference signals always on the same subcarriers.

PSS is used for N_{ID}² signaling and for rough timing and frequency synchronization with the cell. SSS is used for N_{ID}¹ signaling and for more accurate timing and frequency synchronization with the cell. Values of N_{ID}² and N_{ID}¹ representing portions of the cell identification information are required for the UE to determine, when synchronizing with a cell, the cell identifier N_{ID}^{Cell} which the UE connects to access the communication network. The cell identifier N_{ID}^{Cell} is determinable according to the equation N_{ID}^{Cell}=3N_{ID}¹+N_{ID}².

SSS is typically represented by 336 SSS sequences based on gold codes, and the PBCH carrying SI and/or MIB is typically represented by a polar code modulated based on, for example, quadrature phase-shift keying (QPSK), with demodulation reference signals (DMRS) evenly distributed in it (with a certain step, for example, TC=4).

The PRACH preamble used in 5G radio access technology and expected for being used in the next radio access technology (e.g., 6G) is transmitted from the UE to the TRP in a time-frequency resource (PRACH occasion) that is predefined by the specification (see, 3GPP TS 38.211) of the radio access technology and is usually known in advance to the TRP and the UE, which allows the UE transmitter to send the PRACH preamble at the specific time-frequency position and, accordingly, the TRP receiver to detect the PRACH preamble from the given UE at said specific time-frequency position. The PRACH preamble is considered as the reference/service signal, because the preamble transmission from the UE to the TRP allows users wanting to join the network/TRP to initiate procedures such as, but not limited to, an uplink resource request, an initial access (IA), a handover, a reconfiguration and/or link recovery (for example, after a failure), etc.

Other reference signals supporting efficient communication between the UE and the TRP are the CSI-RS reference signals used in 5G radio access technology and expected for being used in the next radio access technology (e.g., 6G). These CSI-RS reference signals can be used at the user side to measure channel information from TRP antennas and report this channel information to the TRP to enable the TRP to perform antenna precoding/beamforming. CSI-RS reference signals include CSI-RS reference signals of the following types: CSI-RS for CSI feedback, CSI-RS for beam management, and/or CSI-RS for tracking.

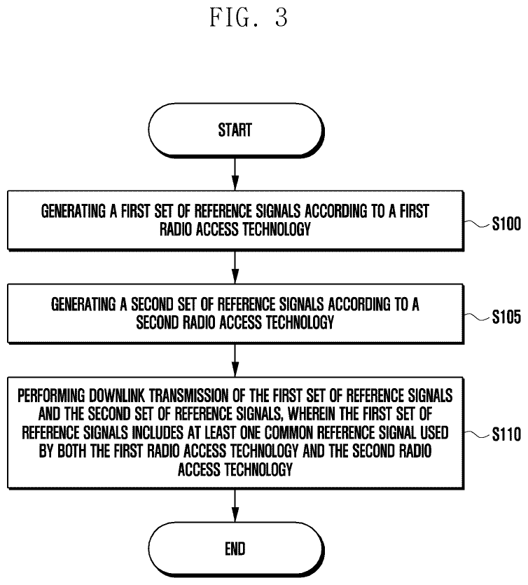

As illustrated in FIG. 3, a flowchart of a communication method may be implemented by the TRP for transmitting reference signals to the UE according to the first aspect of the present disclosure. The method begins and proceeds to step S105 of generating a first set of reference signals according to a first radio access technology. Thereafter, the method proceeds to step S110 of generating a second set of reference signals according to a second radio access technology. In this case, in the first set of reference signals or the second set of reference signals, at least one common reference signal is generated and used by both the first radio access technology and the second radio access technology, other signals in these sets of reference signals can be generated as usual for the corresponding radio access technology, i.e., as specified in the communication standard specifications of the relevant radio access technologies. The first radio access technology may be 5G and the second radio access technology may be 6G, or vice versa. Once the first and second sets of reference signals with the at least one common reference signal are generated, these sets are transmitted on the downlink in step S110 in time-frequency resources predefined in the communication standard specifications of the relevant radio access technologies.

The common reference signal (e.g., 5G/6G PSS or CSI-RS) comprises the same (shared by the radio access technologies) sequence, which can be transmitted in a single time-frequency resource. The term “common reference signal” here also refers to PRACH preambles generated for different radio access technologies, which have sequences orthogonal to each other (i.e., different sequences for different radio access technologies) and transmitted in a single predefined time-frequency resource. Such a predefined time-frequency resource may be a resource predefined by the communication standard specification of one of the radio access technologies (for example, 5G or 6G) supported in the network. The common reference signal transmitted in the predefined time-frequency resource can thus be successfully detected, decoded and used by UEs and TRPs operating in the respective different radio access technologies. This reduces overhead and improves communication network performance.

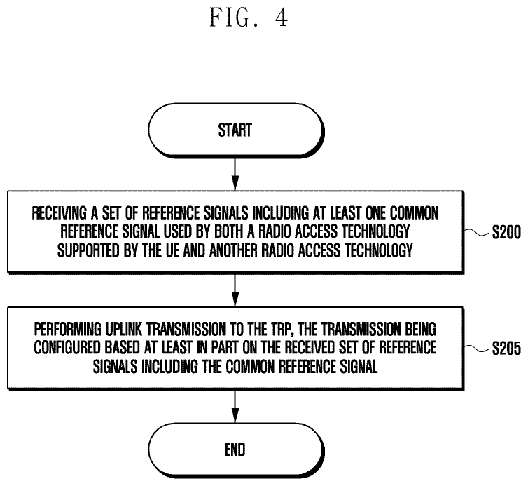

FIG. 4 illustrates a flowchart of a communication method of UE for receiving from TRP reference signals according to various embodiments of the present disclosure. The method includes the steps of: (S200) receiving reference signals, including at least one common reference signal used by both a radio access technology supported by the UE and another radio access technology, (S205) performing uplink transmission to the TRP, the transmission being configured based at least in part on the received reference signals, including based on the common reference signal.

FIG. 5A illustrates the first non-limiting embodiment of the SS/PBCH reference signal block structure with PSS and SSS reference signal sequences shared between 5G and 6G radio access technologies according to the present disclosure. In this embodiment, the PSS (5G/6G PSS) and SSS (5G/6G SSS) reference signals are common to 5G and 6G radio access technologies, and PBCH signals are unique (i.e., in this embodiment, distinct) for 5G and 6G radio access technologies. The generation of the contents of the PSS and SSS reference signal sequences shared between 5G and 6G radio access technologies can be performed similarly to the method defined for the generation of such PSS and SSS reference signals in the specification of the existing radio access technology (for example, 4G LTE, Pre-5G, 5G NR). By way of example, and not limitation, PSS/SSS generation may be implemented as in 5G NR radio access technology, as described in 3GPP TS 38.211.

According to the current 5G NR specification, the composition of the SS/PBCH block, i.e., the types of signals (sync signals) and channels (PBCH) included in the SS/PBCH block, as well as the number of resources on which the SS/PBCH block can be transmitted are predefined (see 3GPP TS 38.211). The specific position of the SS/PBCH block in frequency and time is detected by the UE receiver from a number of possible time-frequency positions of SS/PBCH blocks, which are also defined by the specification (see 3GPP TS 38.104).

The first OFDM symbol (leftmost in FIG. 5A) is allocated for 5G/6G PSS transmission; the second OFDM symbol, a portion of subcarriers of the third OFDM symbol, and the fourth OFDM symbol are allocated for 5G PBCH transmission; the remaining portion of subcarriers of the third OFDM symbol is allocated for 5G/6G SSS transmission, optionally provided with a guard frequency interval (in the non-limiting embodiment shown, the guard frequency interval is 8 subcarriers on each side of the 5G/6G SSS subcarriers); the fifth OFDM symbol and the sixth OFDM symbol are allocated for 6G PBCH transmission.

In this embodiment, the 5G/6G SSS is separated in the third OFDM symbol by frequency from the corresponding portions of the 5G PBCH, and the remaining portions of the reference signals in the illustrated SS/PBCH structure are separated in time, but this should not be considered as a limitation of the disclosed technology, because other variants for arranging/separating reference signals in the time-frequency domain are also possible. The 5G/6G PSS, 5G PBCH, 5G/6G SSS, and 6G PBCH signals may be centered relative to each other on the center subcarrier (see horizontal dashed black line in FIG. 5A) of the frequency resource used to transmit the illustrated SS/PBCH block. This allows the UE implementation to be simplified since, for example, it is not needed in the cell search and synchronization unit of the UE to adjust the center frequency for receiving the SSS upon detection of the PSS. The illustrated embodiment of the SS/PBCH reference signal block structure reduces overhead because when using such SS/PBCH reference signal block, 127*2=254 subcarriers are released due to the use of PSS and SSS reference signal sequences shared between 5G and 6G in this embodiment.

In an alternative that provides similar technical advantages, the 5G PBCH and 6G PBCH can be swapped in the time domain. In yet another alternative (not shown), transmission of the common 5G/6G SSS signal may be provided in the third OFDM symbol as transmission of the ordinary (not common) 5G SSS signal, and transmission of the additional ordinary 6G SSS signal may be provided in the fifth OFDM symbol; in this alternative, the 6G PBCH transmission may be time-shifted into the sixth to seventh OFDM symbols accordingly.

FIG. 5B illustrates the second non-limiting embodiment of the SS/PBCH reference signal block structure with only PSS reference signal sequence shared between 5G and 6G radio access technologies according to the present disclosure. In this embodiment, the PSS (5G/6G PSS) reference signal is common to 5G and 6G radio access technologies, and SSS and PBCH signals are unique (i.e., in this embodiment, distinct) for 5G and 6G radio access technologies. The generation of the contents of the PSS reference signal sequence shared between 5G and 6G radio access technologies can be performed similarly to the method defined for the generation of such PSS reference signal in the specification of the existing radio access technology (for example, 4G LTE, 5G NR). By way of example, and not limitation, PSS generation may be implemented as in 5G NR radio access technology, as described in 3GPP TS 38.211.

According to the current 5G NR specification, the composition of the SS/PBCH block, i.e., the types of signals (sync signals) and channels (PBCH) included in the SS/PBCH block, as well as the number of resources on which the SS/PBCH block can be transmitted are predefined (see 3GPP TS 38.211). The specific position of the SS/PBCH block in frequency and time is detected by the UE receiver from a number of possible time-frequency positions of SS/PBCH blocks, which are also defined by the specification (see 3GPP TS 38.104).

The first OFDM symbol (leftmost in FIG. 5B) is allocated for transmission of the 5G/6G PSS and the first 6G PBCH portions, guard frequency intervals (i.e., a particular number of subcarrier frequencies not used for signal transmission) may be provided in this OFDM symbol between the 5G/6G PSS and the first 6G PBCH portions; the second OFDM symbol is allocated for transmission of the 5G PBCH portion and the subsequent 6G PBCH portions; the third OFDM symbol is allocated for transmission of the subsequent 5G PBCH portions, 5G SSS and the subsequent 6G PBCH portions, guard frequency intervals may be provided in this OFDM symbol between 5G PSS and 5G PBCH portions; the fourth OFDM symbol is allocated for transmission of the last 5G PBCH portion and the last 6G PBCH portions; and the fifth OFDM symbol is allocated for 6G SSS transmission.

In this embodiment, the 5G/6G PSS is separated in the first OFDM symbol from the corresponding 6G PBCH portions by frequency, the 6G PBCH portions in each of the first, second, third and fourth OFDM symbol are separated from the portions of the other reference signals by frequency, 5G SSS is separated in the third OFDM symbol by frequency from the corresponding 5G PBCH and 6G PBCH portions, and the remaining portions of the reference signals in the illustrated SS/PBCH structure are separated in time, but this should not be considered as the limitation of the disclosed technology, because other variants for arranging/separating reference signals in the time-frequency domain are also possible. The 5G/6G PSS, 5G PBCH, 6G PBCH, 5G SSS, and 6G SSS signals may be centered relative to each other on the center subcarrier (see horizontal dashed black line in FIG. 5B) of the frequency resource used to transmit the illustrated SS/PBCH block.

This allows the UE implementation to be simplified since, for example, it is not needed in the cell search and synchronization unit of the UE to adjust the center frequency for receiving the SSS upon detection of the PSS. The illustrated embodiment of the SS/PBCH reference signal block structure allows to reduce overhead because when using such SS/PBCH reference signal block, 127 subcarriers are released due to the use of PSS reference signal sequence shared between 5G and 6G in this embodiment.

In alternative embodiments (not shown) that provide similar technical advantages, the 5G PBCH and 6G PBCH can be swapped in the frequency domain, the 5G SSS and 6G SSS signals can be swapped in the time domain, etc. In yet another alternative (not shown), the distinct 6G SSS signal may not be carried in the fifth OFDM symbol, and the 5G SSS signal carried in the third OFDM symbol may be provided as the common 5G/6G SSS signal (in this alternative embodiment 127*2-254 subcarriers may be released). The advantage of the structure shown in FIG. 5B, compared to the structure shown in FIG. 5A, is that the structure occupies one less OFDM symbol, although the structure requires a slightly wider bandwidth (for the inclusion of the 6G PBCH reference signal).

FIG. 5C illustrates the third non-limiting embodiment of the SS/PBCH reference signal block structure with only PSS reference signal sequence shared between 5G and 6G radio access technologies according to the present disclosure. In this embodiment, the PSS (5G/6G PSS) reference signal is common to 5G and 6G radio access technologies, and SSS and PBCH signals are unique (i.e., in this embodiment, distinct) for 5G and 6G radio access technologies. The generation of the contents of the PSS reference signal sequence shared between 5G and 6G radio access technologies can be performed similarly to the method defined for the generation of such PSS reference signal in the specification of the existing radio access technology (for example, 4G LTE, 5G NR). By way of example, and not limitation, PSS generation may be implemented as in 5G NR radio access technology, as described in 3GPP TS 38.211.

According to the current 5G NR specification, the composition of the SS/PBCH block, i.e., the types of signals (sync signals) and channels (PBCH) included in the SS/PBCH block, as well as the number of resources on which the SS/PBCH block can be transmitted are predefined (see 3GPP TS 38.211). The specific position of the SS/PBCH block in frequency and time is detected by the UE receiver from a number of possible time-frequency positions of SS/PBCH blocks, which are also defined by the specification (see 3GPP TS 38.104).

First three OFDM symbols (leftmost in FIG. 5C) are allocated for 6G PBCH transmission; the fourth OFDM symbol is allocated for 6G SSS transmission; the fifth OFDM symbol is allocated for 5G/6G PSS transmission; the last three OFDM symbols are allocated for 5G PBCH transmission, the subcarrier portion of the second-to-last-one OFDM symbol is allocated for 5G SSS transmission, optionally provided with a guard frequency interval relative to the corresponding 5G PBCH portions also located in this OFDM symbol.

In this embodiment, the 5G SSS is separated in the second-to-last-one OFDM symbol by frequency from the corresponding portions of the 5G PBCH, and the remaining portions of the reference signals in the illustrated SS/PBCH structure are separated in time, but this should not be considered as the limitation of the disclosed technology, because other variants for arranging/separating reference signals in the time-frequency domain are also possible. The 6G PBCH, 6G SSS, 5G/6G PSS, 5G SSS and 5G PBCH signals may be centered relative to each other on the center subcarrier (see horizontal dashed black line in FIG. 5C) of the frequency resource used to transmit the illustrated SS/PBCH block.

This allows the UE implementation to be simplified since, for example, it is not needed in the cell search and synchronization unit of the UE to adjust the center frequency for receiving the SSS upon detection of the PSS. The illustrated embodiment of the SS/PBCH reference signal block structure allows to reduce overhead because when using such SS/PBCH reference signal block, 127 subcarriers are released due to the use of PSS reference signal sequence shared between 5G and 6G in this embodiment.

Another technical advantage of the structure shown in FIG. 5C is that the reference signals enabling 6G communications are transmitted earlier in time than the reference signals enabling 5G communications. Thus, UEs using 6G radio access technology may detect and decode the corresponding reference signals (and perform all subsequent operations) faster than such operations may be performed by UEs using 5G radio access technology. However, this should not be considered as the limitation, since the SS/PBCH reference signal block structure (not shown) is possible in which the reference signals enabling 5G communications are transmitted earlier in time than the reference signals enabling 6G communications. In yet another alternative (not shown), the distinct 6G SSS signal may not be carried in the fourth OFDM symbol, and the 5G SSS signal carried in the second-to-last-one OFDM symbol may be provided as the common 5G/6G SSS signal (in this alternative embodiment 127*2=254 subcarriers may be released, and the fourth OFDM symbol may act as a guard time slot).

Thus, the present disclosure provides many different variants of SS/PBCH reference signal block structures, which may use one or more of: various combinations of time division multiplexing (TDM) and frequency division multiplexing (FDM), various placements of 6G reference signals in adjacent or non-adjacent OFDM symbols with 5G reference signals, different or identical time durations of subcarriers used, different frequency bands of greater or lesser width, different orders of reference signals or portions thereof, etc.

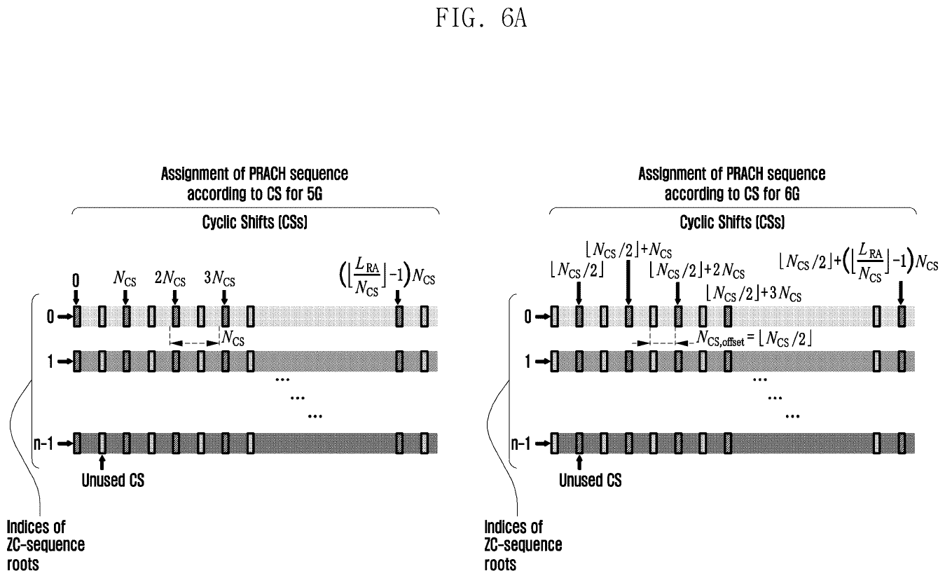

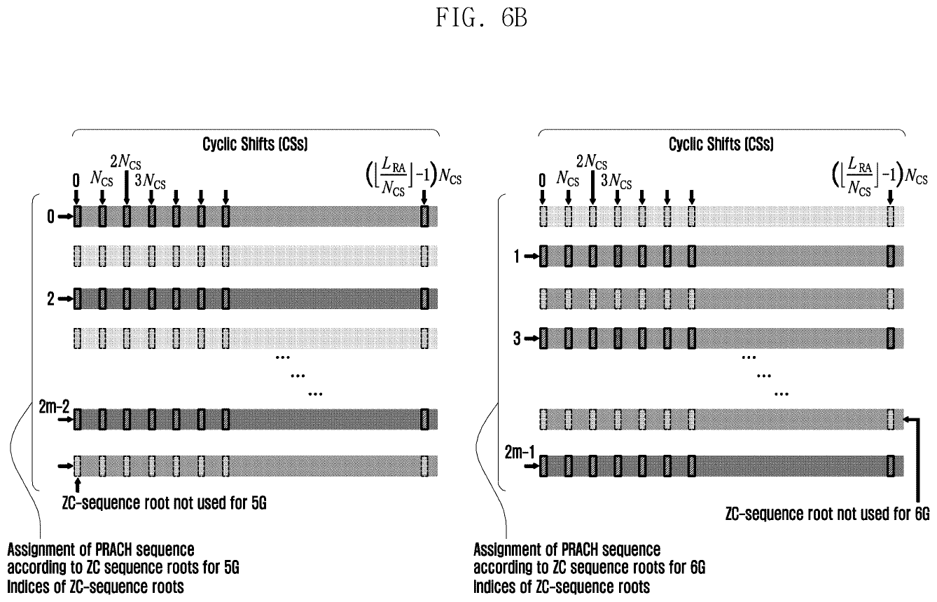

Next, with reference to FIG. 6 the generation of PRACH preambles (which may also be referred to as PRACH sequences) with the PRACH preamble sequences sharing between 5G and 6G radio access technologies by applying different values of one or more different parameters according to the present disclosure will be described in detail.

For a transmission of PRACH preambles, a single time-frequency resource may be dynamically allocated or configured in advance between the TRP and the UE (e.g., at the entire network level or at the cell(s) level), in which UEs of different radio access technologies are allowed to transmit to the TRP Zadoff-Chu (ZC) sequence-based different PRACH preambles of the corresponding radio access technologies. Therefore, such a resource can be considered as the common time-frequency resource. ZC sequences have constant amplitude and zero autocorrelation for all non-zero time offset values, making them advantageous to use as PRACH sequences.

In 5G NR technology, the following PRACH preamble formats are supported, specified in the following Table 1 with their corresponding characteristics (Formats 0-3 represent long preamble formats, the remaining formats listed represent short preamble formats):

TABLE 1
PRACH preamble formats

| | | | Number of |
|---|---|---|---|
| | L_{RA} (length | Numerology | repetitions of the |
| | of ZC se- | (spacing between | PRACH preamble to |
| PRACH | quence that | subcarriers, | increase coverage and |
| pre- | can be used | SCS, which are | support different |
| amble | for PRACH | used to transmit the | TRP beamforming |
| format | preamble) | PRACH preamble) | switching techniques |
| 0 | 839 | 1.25 kHz (not used | 1 |
| | | for data | |
| | | transmission) | |
| 1 | 839 | 1.25 kHz | 2 |
| 2 | 839 | 1.25 kHz | 4 |
| 3 | 839 | 5 kHz | 1 |
| A1 | 139, 1151, 571 | μ = 0, 1, 2, 3, 4, 5, 6 | 2 |
| | | For example, | |
| | | μ = 0 -> 15 kHz | |
| | | μ = 1 -> 15 kHz * | |
| | | 2¹ = 30 kHz | |
| | | μ = 1 -> 15 kHz * | |
| | | 2² = 60 kHz etc. | |
| A2 | 139, 1151, 571 | μ = 0, 1, 2, 3, 4, 5, 6 | 4 |
| A3 | 139, 1151, 571 | μ = 0, 1, 2, 3, 4, 5, 6 | 6 |
| B1 | 139, 1151, 571 | μ = 0, 1, 2, 3, 4, 5, 6 | 2 |
| B2 | 139, 1151, 571 | μ = 0, 1, 2, 3, 4, 5, 6 | 4 |
| B3 | 139, 1151, 571 | μ = 0, 1, 2, 3, 4, 5, 6 | 6 |
| B4 | 139, 1151, 571 | μ = 0, 1, 2, 3, 4, 5, 6 | 12 |
| C0 | 139, 1151, 571 | μ = 0, 1, 2, 3, 4, 5, 6 | 1 |
| C2 | 139, 1151, 571 | μ = 0, 1, 2, 3, 4, 5, 6 | 4 |

The ZC-based sequence is generated according to the following math. equation 1:

$${x}_{u} ( i ) = {e}^{- j \frac{π ui ( i + 1 )}{{L}_{RA}}} \qquad equation 1$$

where: xᵤ is the ZC sequence being generated;
e is Euler's number/exponent;
π is the number of pi;
j is the complex imaginary unit;
i is the element i of the ZC sequence being generated, 0≤i≤L_{RA}−1;
L_{RA} is the sequence length, depending on the PRACH preamble format and a specific network deployment scenario, a sequence of a certain length is used, L_{RA}={139,839,1151,571} (according to Table 1); and
u is the root of the ZC sequence.

From the ZC sequence with root u, different PRACH preambles can be generated by applying different cyclic shifts in accordance with equation 2:

$${x}_{u , v} ( n ) = {x}_{u} ( ( n + {C}_{v} ) mod {L}_{RA} ) \qquad equation 2$$

where: x_{u,v} is the cyclically shifted ZC sequence that is the PRACH preamble;
n is the index of the element of the cyclically shifted ZC sequence, 0≤n≤L_{RA}−1;
xᵤ is the original ZC sequence;
Cᵥ is the parameter specifying a certain cyclic shift; and
mod is the operation of division with remainder.

The Cᵥ parameter for the normal mobility scenario involving non-restricted set of cyclic shifts is defined according to the following equation 3:

$${C}_{v} = \{ \begin{matrix}{vN}_{CS} \\ 0\end{matrix} \\ where : v = 0 , 1 , … , ⌊ \frac{{L}_{RA}}{{N}_{CS}} ⌋ - 1 , {N}_{CS} \neq 0 ; \qquad equation 3$$

L_{RA} is the sequence length;
N_{CS} is the cyclic shift step;

$$⌊ \frac{{L}_{RA}}{{N}_{CS}} ⌋$$

is the number of possible cyclic shifts; and
└ ┘ is the rounding operation (floor) to the nearest smallest integer.

Also, the restricted set of cyclic shifts may also be provided to serve UEs, which is used to serve UEs moving at high speeds to minimize or eliminate the potential for unwanted correlation effects existing during such movement, caused by the Doppler frequency shift. In this embodiment, the Cᵥ parameter for the high mobility scenario is generally determined according to the following equation 4:

$${C}_{v} = {d}_{start} ⌊ v / {n}_{shift}^{RA} ⌋ + ( v mod {n}_{shift}^{RA} ) {N}_{CS} \qquad equation 4$$

The present disclosure is intended primarily for use in the normal mobility scenario in which the math. expression 3 is used, but it also can be used, with appropriate modifications, for the high mobility scenario in which the equation 4 is used.

There are 64 preambles defined in each time-frequency resource allocated for PRACH and numbered in ascending order of, first, increasing cyclic offset (e.g., from a set of available cyclic offsets) of the root sequence, and then in ascending order of the sequence root index (e.g., according to the set of sequence roots), starting with the index derived from the higher-level protocol parameter (syntax element), prach-RootSequenceIndex or rootSequenceIndex-BFR, or from msgA-PRACH-RootSequenceIndex, if configured, and type 2 random access procedure is initiated, as described in 3GPP TS 38.213. Additional preamble sequences, in case 64 preambles cannot be generated from a single root ZC sequence, are obtained from the root sequences with the following logical indices until all 64 sequences are determined.

The root u of the ZC sequence is determined according to the following equation 5:

$$u = f ( i ) \qquad equation 5$$

where:
i is the ZC sequence root index, signaled, for example, by the prach-RootSequenceIndex parameter; and
f(i) is the function mapping value i to the initial value u preconfigured for this i; this mapping for ZC sequence length L_{RA}=139 is performed according to the following Table 2 (mappings for other L_{RA} sequence lengths, which can be used here without any limitations, is illustrated in 3GPP TS 38.211).

TABLE 2
Mapping i to u for ZC sequence length L_{RA} = 139

| i | Initial root u of the ZC sequence in ascending order of i | | | | | | | | | | | | | | | | | | | |
|---|---|---|---|---|---|---|---|---|---|---|---|---|---|---|---|---|---|---|---|---|
| 0- | 1 | 138 | 2 | 137 | 3 | 136 | 4 | 135 | 5 | 134 | 6 | 133 | 7 | 132 | 8 | 131 | 9 | 130 | 10 | 129 |
| 19 | | | | | | | | | | | | | | | | | | | | |
| 20- | 11 | 128 | 12 | 127 | 13 | 126 | 14 | 125 | 15 | 124 | 16 | 123 | 17 | 122 | 18 | 121 | 19 | 120 | 20 | 119 |
| 39 | | | | | | | | | | | | | | | | | | | | |
| 40- | 21 | 118 | 22 | 117 | 23 | 116 | 24 | 115 | 25 | 114 | 26 | 113 | 27 | 112 | 28 | 111 | 29 | 110 | 30 | 109 |
| 59 | | | | | | | | | | | | | | | | | | | | |
| 60- | 31 | 108 | 32 | 107 | 33 | 106 | 34 | 105 | 35 | 104 | 36 | 103 | 37 | 102 | 38 | 101 | 39 | 100 | 40 | 99 |
| 79 | | | | | | | | | | | | | | | | | | | | |
| 80- | 41 | 98 | 42 | 97 | 43 | 96 | 44 | 95 | 45 | 94 | 46 | 93 | 47 | 92 | 48 | 91 | 49 | 90 | 50 | 89 |
| 99 | | | | | | | | | | | | | | | | | | | | |
| 100- | 51 | 88 | 52 | 87 | 53 | 86 | 54 | 85 | 55 | 84 | 56 | 83 | 57 | 82 | 58 | 81 | 59 | 80 | 60 | 79 |
| 119 | | | | | | | | | | | | | | | | | | | | |
| 120- | 61 | 78 | 62 | 77 | 63 | 76 | 64 | 75 | 65 | 74 | 66 | 73 | 67 | 72 | 68 | 71 | 69 | 70 | — | — |
| 137 | | | | | | | | | | | | | | | | | | | | |
| 138- | N/A | | | | | | | | | | | | | | | | | | | |
| 837 | | | | | | | | | | | | | | | | | | | | |

As an example, if the ZC sequence root index signaled, for example, by the parameter prach-RootSequenceIndex, is 41, it is determined that the initial root u of the ZC sequence in this case may be 118; if the ZC sequence root index is 42, it is determined that the root u of the ZC sequence in this case may be 22, etc.

The cyclic step value N_{CS} can be determined according to pre-configured information (for example, depending on zero correlation zones predefined by the network operator) given in the following Table 3 for preamble formats in which SCS is equal to 1.25 kHz (for preamble, formats with other SCS values, the corresponding N_{CS} value tables, which can be used here without any limitations, are illustrated in the 3GPP TS 38.211).

TABLE 3
N_{CS} value for preamble formats with SCS = 1.25 kHz

| | Value N_{CS} | | |
|---|---|---|---|
| | Unrestricted | | |
| Zero | set (Normal | | |
| correlation | Mobility | Type A of the | Type B of the |
| zone | Scenario) | restricted set | restricted set |
| 0 | 0 | 15 | 15 |
| 1 | 13 | 18 | 18 |
| 2 | 15 | 22 | 22 |
| 3 | 18 | 26 | 26 |
| 4 | 22 | 32 | 32 |
| 5 | 26 | 38 | 38 |
| 6 | 32 | 46 | 46 |
| 7 | 38 | 55 | 55 |
| 8 | 46 | 68 | 68 |
| 9 | 59 | 82 | 82 |
| 10 | 76 | 100 | 100 |
| 11 | 93 | 128 | 118 |
| 12 | 119 | 158 | 137 |
| 13 | 167 | 202 | — |
| 14 | 279 | 237 | — |
| 15 | 419 | — | — |

The totalNumberOfRA-Preambles parameter may be used for configuring the total number of preambles. If the use of all available cyclic shifts (according to the set of available cyclic shifts) of the ZC sequence obtained according to a certain root did not allow obtaining the required amount of PRACH preambles for transmission in a common time-frequency resource, switching to the PRACH preambles generation according to the ZC sequence obtained according to the next available sequence root according to the set of sequence roots can be made, etc.

As illustrated in FIG. 6A, the first non-limiting embodiment PRACH preamble sequences sharing between 5G and 6G radio access technologies by applying different cyclic shift step values is provided according to the present disclosure. The left diagram in FIG. 6A is the generation of PRACH preambles for transmission in a single time-frequency resource for the first radio access technology (5G radio access technology in this example). The right diagram in FIG. 6A is the generation of PRACH preambles for transmission in the same single time-frequency resource for the second radio access technology (6G radio access technology in this example).

The left diagram in FIG. 6A is the generation of PRACH preambles for the first radio access technology (in this example 5G) from ZC sequences obtained respectively from the sequence root values specified respectively by the indices 0, 1, . . . , n−1, where n is the total number of different sequence roots, with the cyclic shift step N_{CS} (without offset). The right diagram in FIG. 6A is the generation of PRACH preambles for the second radio access technology (in this example 6G) from ZC sequences obtained respectively from the same sequence root values specified respectively by the indices 0, 1, . . . , n−1, but with the cyclic shift step N_{CS} having the sequence cyclic shift offset N_{CS,offset}=[N_{CS}/2]. Therefore, the set of cyclic shifts that may be used in this example for generating 5G PRACH preambles may include cyclic shifts 0, N_{CS},

$$2 {N}_{CS} , 3 {N}_{CS} , … , ( ⌊ \frac{{L}_{RA}}{{N}_{CS}} ⌋ - 1 ) {N}_{CS} etc .$$

and the set of cyclic shifts that may be used in this example for generating 6G PRACH preambles may include cyclic shifts

$$⌊ {N}_{CS} / 2 ⌋ , ⌊ {N}_{CS} / 2 ⌋ + {N}_{CS} , ⌊ {N}_{CS} / 2 ⌋ + 2 {N}_{CS} , \\ ⌊ {N}_{CS} / 2 ⌋ + 3 {N}_{CS} , … , ⌊ {N}_{CS} / 2 ⌋ + ( ⌊ \frac{{L}_{RA}}{{N}_{CS}} ⌋ - 1 ) {N}_{CS} etc .$$

With this sets of non-overlapping cyclic shifts for different radio access technologies provided are different PRACH preambles that can be transmitted in the same time-frequency resource (i.e., during the same PRACH occasion). In the alternative embodiment, what is shown on the left in FIG. 6A can be used to generate 6G PRACH preambles, and what is shown on the right in FIG. 6A can accordingly be used to generate 5G PRACH preambles.

Thus, the cyclic shifts used for generation of different PRACH preambles of respectively different radio access technologies from the ZC sequence are selected according to the present disclosure such that there is no complete overlap between the generated PRACH preamble sequences making it possible to generate from the single ZC sequence a plurality of unique PRACH preamble sequences that have zero autocorrelation for all offsets except zero. The sharing of PRACH preamble sequences between different radio access technologies should not be limited to the described implementations, since it is clear that, if necessary, it is possible to provide greater or lesser spacing between the PRACH preamble sequences of different radio access technologies. To this end, the cyclic shift offset N_{CS,offset}=└N_{CS}/2┘ for the second radio access technology can be set to any integer value that is greater or less than N_{CS,offset}=└N_{CS}/2┘, for example, N_{CS,offset}=└N_{CS}/3┘, N_{CS,offset}=└2N_{CS}/3┘ N_{CS,offset}=└N_{CS}/4┘, N_{CS,offset}=└3N_{CS}/4┘ etc. In another example, the ZC sequence may be separated into PRACH preambles for a number of radio access technologies greater than 2 using appropriately selected cyclic shifts.

The following is the mathematical description of the non-limiting example of separating PRACH preamble sequences of different radio access technologies for transmission in a single time-frequency resource according to different cyclic shift offset values. The ZC sequence can be generated according to the above described equation 1. After this, the PRACH preamble of one radio access technology can be generated according to the above described equation 1, and the cyclically shifted PRACH preamble of the other radio access technology can be generated according to the following modified equation 2.1:

$${x}_{u , v} ( n ) = {x}_{u} ( ( n + {C}_{v} + {N}_{CS , offset} ) mod {L}_{RA} ) \qquad modified equation 2.1$$

where: x_{u,v} is the cyclically shifted ZC sequence;
n is the index of the element of the cyclically shifted ZC sequence, 0≤n≤L_{RA}−1
xᵤ is the original ZC sequence;
Cᵥ is the parameter specifying a certain cyclic shift determined according to the equation 3 for normal mobility or, alternatively, according to equation 4 for high mobility;
N_{CS,offset} is the sequence cyclic shift offset; and
A mod B is the operation of taking the remainder from dividing A by B.

The following is the non-limiting example of configuring the network to support DSS with reference signal sequence sharing through the use of different cyclic shifts. In this example implementation: a time-frequency resource of PRACH channel can be (a) predefined (for example, at the side of the TRP, TRP equipment manufacturer or network operator) and known in advance to the TRP and the UE of one radio access technology (for example, 5G) for transmitting the PRACH preamble of that radio access technology. For transmission of a PRACH preamble of another radio access technology, the same resource of the PRACH channel may be (b) predefined for the TRP and the UE of that other radio access technology. In this example, a single TRP may be used that simultaneously supports both radio access technologies, and the PRACH channel resource may be a single (common) time-frequency resource due to the execution of at least step (b).

The sequence of operations in this example may further include: (c) configuring different cyclic shifts as described above with reference to FIG. 6. Optionally, in step (c), the initial cyclic shift may be set, for example as an index of a particular starting cyclic shift from a set of possible cyclic shifts; for example, index 2 of the cyclic shift set illustrated in the left diagram in FIG. 6A may specify cyclic shift 3 as the initial cyclic shift, etc.). With this configuration, the UE supporting the first radio access technology (5G in this example) can follow the conventional 5G procedure, i.e., generate the PRACH preamble, for example, according to the above-described equations 2, 3 and transmit the generated PRACH preamble in a predefined time-frequency resource, and the UE supporting the second radio access technology (6G in this example) can follow the modified procedure, i.e., generate the PRACH preamble as described above with reference to FIG. 6A and modified equation 2.1 and transmit the generated PRACH preamble in the same predefined time-frequency resource.

As illustrated in FIG. 6B, the second non-limiting embodiment PRACH preamble sequences sharing between 5G and 6G radio access technologies by applying different roots of ZC sequence is provided according to the present disclosure. The left diagram in FIG. 6B is the generation of PRACH preambles for transmission in the single time-frequency resource for the first radio access technology (5G radio access technology in this example). The right diagram in FIG. 6B is the generation of PRACH preambles for transmission in the same time-frequency resource for the second radio access technology (6G radio access technology in this example).

The left diagram in FIG. 6B is the generation of PRACH preambles for the first radio access technology (in this example 5G) from ZC sequences obtained respectively from the values of possible sequence roots, specified by the indices 0, 2, . . . , 2m−2, where n=2m, and n is the total number of different sequence roots. The right diagram in FIG. 6B is the generation of PRACH preambles for the second radio access technology (in this example 6G) from ZC sequences obtained from the values of the other possible sequence roots, specified respectively by the indices 1, 3, . . . , 2m−1. The actual values of the roots of the ZC sequence, specified by the indices described above, can be determined as described above with reference to equation 5 and Table 2.

What is shown in FIG. 6B differs from what is shown in FIG. 6A in that for the generation of PRACH preambles of different radio access technologies in the embodiment of FIG. 6B the sets of non-overlapping cyclic shifts are not used, but used are sets of non-overlapping roots of ZC sequence. Therefore, in this embodiment, the same set of cyclic shifts

$$0 , {N}_{CS} , 2 {N}_{CS} , 3 {N}_{CS} , … , ( ⌊ \frac{{L}_{RA}}{{N}_{CS}} ⌋ - 1 ) {N}_{CS}$$

is used for both radio access technologies, as illustrated in FIG. 6B. According to FIG. 6B, the set of ZC sequence roots for the first radio access technology includes ZC sequence roots with indices 0, 2, . . . , 2m−2, and the set of ZC sequence roots for the second radio access technology includes ZC sequence roots with indices 1, 3, . . . , 2m−1. In the alternative embodiment, what is shown on the left in FIG. 6B can be used to generate 6G PRACH preambles, and what is shown on the right in FIG. 6B can accordingly be used to generate 5G PRACH preambles.

Thus, the distinguishability of PRACH preambles in this embodiment is ensured by the use of different roots of the Zadoff-Chu sequence for different radio access technologies. At the same time, the alternative embodiment of the separation is possible when, for different radio access technologies, the ZC sequence roots are selected not to be interleaved according to the even/odd number of the used roots of the sequence, as described above with reference to FIG. 6B, but according to another logic, for example, with the separation of the entire plurality of available ZC-sequence roots into two or more portions according to the number of radio access technologies for which it is necessary to ensure the possibility of coexistence in a single time-frequency resource.

For example, the first half of the plurality of available ZC sequence roots is used for the first radio access technology, and the second half of the plurality of available ZC sequence roots is used for the second radio access technology, or vice versa. An alternative combined embodiment is also possible in which the separation of PRACH preamble sequences is carried out using the method described above with reference to FIG. 6A and using the method described above with reference to FIG. 6B.

The following is the non-limiting example of configuring the network to support DSS with reference signal sequence sharing through the use of different roots of ZC sequence. In this example implementation: a time-frequency resource of PRACH channel can be (a) predefined (for example, at the side of the TRP, TRP equipment manufacturer or network operator) and known in advance to the TRP and the UE of one radio access technology (for example, 5G) for transmitting the PRACH preamble of that radio access technology.

For transmission of a PRACH preamble of another radio access technology, the same resource of the PRACH channel may be (b) predefined for the TRP and the UE of that other radio access technology. In this example, a single TRP may be used that simultaneously supports both radio access technologies, and the PRACH channel resource may be a single (common) time-frequency resource due to the execution of at least step (b). The sequence of operations in this example may further include: (c) configuring different roots of the Zadoff-Chu sequence used for generation of PRACH preambles for the use by UEs of different radio access technologies. In the non-limiting implementation of the step (c), the logical index of the root/the set of sequence roots for the first radio access technology (e.g., 5G) can be set equal to a value/a set of values i, respectively, and the logical index of the root/the set of sequence roots for the second radio access technology (e.g., 6G) can be set equal to, respectively, a value/a set of values i that does not overlap with said value/said set of values i.

Thus, the possibility of using the same time-frequency resource for different radio access technologies is ensured by the use of PRACH preamble sequences sharing between different radio access technologies, provided by a pre-configuration between the TRP and UEs (for example, according to a predefined communication standard specification) and/or via the transmitted system information (SI): different cyclic shifts and/or different roots of the ZC sequence to be received on the UEs side of different radio access technologies and applied to the ZC sequence to generate corresponding different PRACH preambles to be transmitted to the TRP in said one time-frequency resource.

Said parameter, as described above, may be a cyclic shift N_{CS} and a cyclic shift offset N_{CS,offset} defining a set of cyclic shifts applied, for example one after another, to cyclically shift the ZC sequence to generate from that ZC sequence different PRACH preamble sequences of different radio access technologies. In addition to the above parameters, an initial cyclic shift (e.g., as an index of a particular cyclic shift from a set of cyclic shifts) specifying the cyclic shift to be applied as the first cyclic shift may optionally be set and signaled to the UE. The set of cyclic shifts is defined as

$$⌊ \frac{{L}_{RA}}{{N}_{CS}} ⌋ ,$$

where L_{RA} is the length of the ZC sequence, N_{CS} is the cyclic shift. Another possible parameter, which can be applied independently or in combination with said is the logical index i of the root of the ZC sequence, prach-RootSequenceIndex, specifying, through the mapping according to the equation 5, the initial root u of the ZC sequence from the set of possible sequence roots, to be applied to generate the PRACH preamble from the predefined ZC sequence.

Another reference signal that may be used in both the first radio access technology and the second radio access technology is CSI-RS. The CSI-RS may include one or more of: CSI-RS for CSI feedback; CSI-RS for beam management; and/or CSI-RS for tracking. According to an embodiment, a common CSI reference signal may be generated for both radio access technologies and received/transmitted on the same time-frequency resource. In a non-limiting example, at the TRP or the UE of the second radio access technology (e.g., 6G), the CSI-RS generation method may be inherited as such from the first radio access technology (e.g., 5G).

The following is a non-limiting example of configuring a network to support DSS using common CSI-RS. In this example implementation: a time-frequency resource of CSI-RS channel can be (a) predefined (for example, at the side of the TRP, TRP equipment manufacturer or network operator) and known in advance to the TRP and the UE of one radio access technology (for example, 5G) for transmitting the CSI-RS of that radio access technology. For transmission of CSI-RS of another radio access technology, the same resource of the CSI-RS channel may be (b) predefined for the TRP and the UE of that other radio access technology. In this example, a single TRP may be used that simultaneously supports both radio access technologies, and the CSI-RS channel resource may be a single (common) time-frequency resource due to the execution of at least step (b). The sequence of operations in this example may further include: (c) at the TRP or the UE of the second radio access technology (e.g., 6G), the CSI-RS generation method may be implemented as such in the first radio access technology (e.g., 5G), or vice versa.

The following is the non-limiting mathematical description of one possible method of generating CSI-RS that can be used in the present disclosure. The initial state of a pseudorandom binary sequence (PRBS) can be determined according to the following equation 6:

$${c}_{init} = ( {2}^{10} ( {N}_{symb}^{slot} {n}_{s , f}^{μ} + l + 1 ) ( 2 {n}_{ID} + 1 ) + {n}_{ID} ) mod {2}^{31} \qquad equation 6$$

where:
cᵢₙᵢₜ is the initial state of the generator of the pseudo noise sequence that may be used to obtain the CSI-RS sequence;
N_{symb}^{slot} is the number of symbols per slot;
n_{s,f}^{μ} is the slot number in the radio frame;
l is the index of the OFDM symbol in the time domain in the slot;
n_{ID} is the CSI-RS sequence identifier; and
A mod B is the operation of taking the remainder from dividing A by B.

CSI-RS modulation can be performed according to the following equation 7:

$$r ( m ) = \frac{1}{\sqrt{2}} ( 1 - 2 c ( 2 m ) ) + j \frac{1}{\sqrt{2}} ( 1 - 2 c ( 2 m + 1 ) ) \qquad equation 7$$

where:
r is the modulated pseudo-random sequence for CSI-RS;
m is the index of the CSI-RS symbol in the sequence r;
j is the imaginary unit; and
c is the previously generated pseudonoise sequence.

The CSI-RS signal in the resource grid can be defined according to the following equation 8:

$${α}_{k , l}^{( p , μ )} = {β}_{CSIRS} {w}_{f} ( {k}^{′} ) {w}_{t} ( {l}^{′} ) {r}_{l , {n}_{s , f}} ( {m}^{′} ) \qquad equation 8$$

where:
α is the CSI-RS signal in the resource grid;
k is the logical index of the subcarrier used to transmit the CSI-RS signal, determined as k=nN_{sc}^{RB}+k̅+k′, parameters k and k′ are auxiliary indices and can be determined according to 3GPP TS 38.211;
l is the index of OFDM symbol inside the slot, determined as l=l̅+l′, parameters I and l′ are auxiliary indices and can be determined according to 3GPP technical specification TS 38.211;
β_{CSIRS} is the power control parameter defined by the powerControlOffsetSS parameter in the NZP-CSI-RS-Resource (RRC) information element;
w_{f}(k′), wₜ(l′) are orthogonal sequences, respectively, in the frequency and time domain, defined, for example, according to 3GPP TS 38.211;
r_{l,n}_{_{s,f}} is the modulated pseudorandom sequence CSI-RS, obtained according to the above described equation 7; and
m′ is the auxiliary index determined according to

$${m}^{′} = ⌊ n / α ⌋ + {k}^{′} + ⌊ \frac{\overline{k} ρ}{{N}_{sc}^{RB}} ⌋ , where α = \{ \begin{matrix}ρ for X = 1 \\ 2 ρ for X > 1\end{matrix} ,$$

where ρ is the density in CSI-RS-ResourceMapping (RRC), X is the number of ports (parameter) nrofPorts B CSI-RS-ResourceMapping (RRC).

Other features of CSI-RS generation not explicitly mentioned here can be implemented according to, for example, the technical specification TS 38.211.

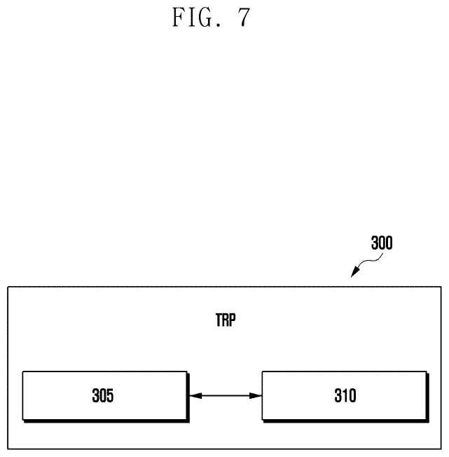

FIG. 7 illustrates the schematic representation of the TRP 300 according to the second aspect of the present disclosure, which is configured to perform the communication method according to the first aspect of the present disclosure due to at least that the TRP includes a transmitting-receiving antenna unit 305 configured to communicate with UE and any other devices being within the coverage area of the respective cell, and a processor 310 operatively coupled with the transmitting-receiving antenna unit 305 and configured to perform the method according to the first aspect of the present disclosure or according to any possible implementation of the first aspect of the present disclosure. The TRP may be, but not limited to, base station (BS), access point (AP), or Node B, eNode B (eNB), gNode B (gNB).

The TRP 300 is shown in FIG. 7 in a relatively simplistic, schematic form, therefore shown in this figure are not all components actually comprised in the TRP 300, but only those components with which the present disclosure is carried out. As is known, the TRP may comprise another components not shown in FIG. 7, for example, a power supply, various interfaces, I/O means, interconnections, random access and read-only memory storing instructions executable by the processor 310 to carry out the method according to the first aspect of the present disclosure or according to any possible implementation of the first aspect of the present disclosure, as well as an operating system, etc. The transmitting-receiving antenna unit 305 may comprise a transceiver and an antenna coupled to each other. The antenna can be implemented as a massive or extremely massive MIMO antenna array with a large number of antenna ports, which supports hybrid analog and digital beamforming capabilities.

The processor 310 of the TRP 300 may be a central processing unit, a special-purpose processor, another processing unit, for example, a graphics processing unit (GPU), or a combination thereof. The processor 310 may be implemented as a circuit, for example as a field-programmable gate array (FPGA), an application-specific integrated circuit (ASIC), a system-on-chip (SoC), etc.

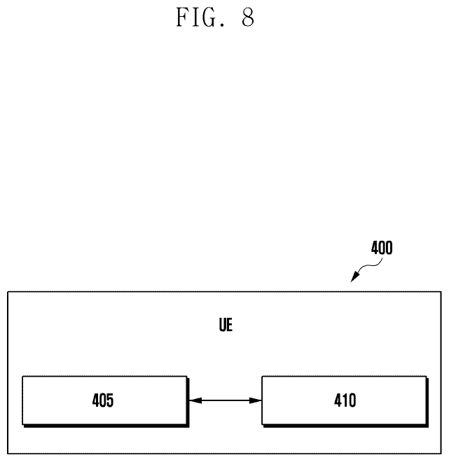

FIG. 8 illustrates the schematic representation of the UE 400 according to the fifth aspect of the present disclosure, which is configured to perform the communication method according to the fourth aspect of the present disclosure due to at least that the UE includes a transmitting-receiving antenna unit 305 configured to communicate with TRP and any other devices being within the coverage area of the respective cell, and a processor 410 operatively coupled with the transmitting-receiving antenna unit 405 and configured to perform the method according to the fourth aspect of the present disclosure or according to any possible implementation of the fourth aspect of the present disclosure. The UE may be, but is not limited to, a mobile phone, a tablet, a laptop, a personal computer, a user wearable electronic device (for example, glasses, watches), AR/VR headset, “Internet of Things (IoT)” device, in-vehicle equipment or any other mobile communications-enabled electronic devices. The UE may be referred to differently, for example, as a user terminal, a user device, a subscriber device, etc.

The UE 400 is shown in FIG. 8 in a relatively simplistic, schematic form, therefore shown in this figure are not all components actually comprised in the UE 400, but only those components with which the present disclosure is carried out. As is known, the UE may comprise another components not shown in FIG. 8, for example, a power supply, battery, various interfaces, I/O means, interconnections, random access and read-only memory storing instructions executable by the processor 410 to carry out the method according to the fourth aspect of the present disclosure or according to any possible implementation of the fourth aspect of the present disclosure, as well as an operating system, etc. The transmitting-receiving antenna unit 405 may comprise a transceiver and an antenna coupled to each other. The antenna can be implemented as a massive or extremely massive MIMO antenna array with a large number of antenna ports, which supports hybrid analog and digital beamforming capabilities.

The processor 410 of the UE 400 may be a central processing unit, a special-purpose processor, another processing unit, for example, a graphics processing unit (GPU), or a combination thereof. The processor 410 may be implemented as a circuit, for example as FPGA, ASIC, SoC, etc.

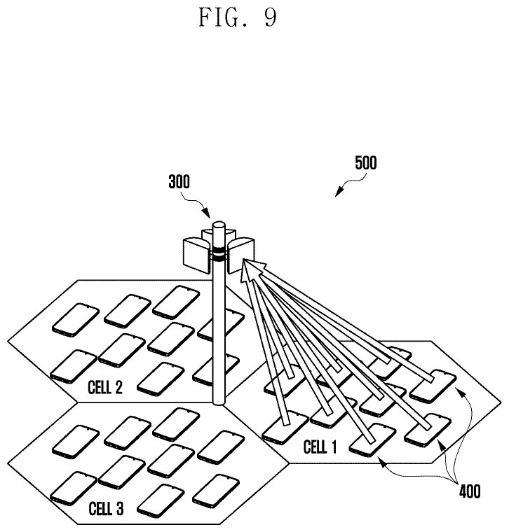

FIG. 9 illustrates a schematic representation of a communication system 500 according to the seventh aspect of the present disclosure. The communication system 500 comprises one TRP 300, which is installed to serve UEs 400 in three deployed cells 1, 2, 3. The transmit-receive point 300 may correspond to the TRP 300 that is described above in detail with reference to FIG. 7, and each user equipment 400 may correspond to the UE 400 that is described above in detail with reference to FIG. 8, so the detailed description of the TRP 300 and UE 400 are not given here again. The communication system 500 may simultaneously support two active radio access technologies (RATs) from, for example, 4G LTE, 5G NR, 6G.

Specific details shown in FIG. 9 should not be construed as the limitations of the present technology, because the system 500 may have a different architecture and may be characterized/illustrated differently, for example, each cell of the cell 1, cell 2, cell 3 may correspond to the system's own TRP 300, a number of UE 400 in the cells may differ from the number shown, the cells 1, 2, 3 may be a single larger cell, a shape and space covered by the cells may differ from the ones shown, etc. The number of cells can be more or less than 3.

The present disclosure may further be implemented as the storage medium storing processor executable instructions, which, when executed by the processor of a device equipped with a transmitting-receiving antenna unit, ensure the performance of the method according to any aspect of the present disclosure or according to any possible implementation of the corresponding aspect. The storage medium may be any persistent (non-transitory) computer-readable medium, a memory, a memory area, a storage device, etc., for example, but not limited to, a hard disk, an optical medium, a semiconductor medium, a solid state drive (SSD) or similar.

The technical solutions disclosed in the present application provide communication methods and communication devices that ensure improved DSS by at least partially sharing the reference signal sequences of different radio access technologies supported in the network (see in FIG. 2 the central area related to DSS). Such partial sharing of the reference signal sequences of radio access technologies supported in the network reduces overhead and, as a result, increases communication performance.

The present disclosure can be used in 3GPP specification-compliant communication networks with TRPs and UEs, which support massive MIMO antenna technology with an extremely large number of digital antenna ports (e.g., ≥128), analog/digital single-beam/multi-beam beamforming, and TDD and/or FDD duplex modes. Other applications of the technology disclosed herein will become apparent to those ordinary skilled in the art upon reading this detailed description of the present application.

At least one feature of the disclosed technical solution can be implemented by artificial intelligence (AI) model. The function associated with the AI can be performed by a read-only memory, random access memory, and processor(s) (CPU, GPU, NPU). The processor(s) controls the processing of input data in accordance with a predefined operating rule or an AI model stored in read-only memory and random access memory. The predefined operating rule or AI model is provided through training. In this case, “provided through training” means that by applying a learning algorithm to plurality of training data, a predetermined operation rule or AI model of the required characteristic is created. By way of non-limiting examples: an AI model may be created to generate a reference signal to be transmitted/received in a particular case, or at least one value of a particular parameter to be applied in reference signal generation not implemented through the AI.

Such AI-mediated generation of a reference signal or at least a parameter value may be performed depending on one or more of the current TRP and/or UE configurations, current communication network conditions and so on. In this case, any data describing the current TRP and/or UE configurations, current conditions in the communication network, can be used as training data to train such an AI model. The training may be performed in a device itself in which AI according to the embodiment is implemented, and/or may be implemented through a separate server/system.

The AI model can be a decision tree based algorithm or may consist of a plurality of neural network layers. Each layer has a plurality of weights and performs the operation of the layer through a calculation based on the result of the calculation in the previous layer and the application of a plurality of weights and other parameter values. Examples of decision tree based algorithms include a random forest, tree ensembles, etc., and examples of neural networks include, among others, convolutional neural network (CNN), deep neural network (DNN), recurrent neural network (RNN), restricted Boltzmann machine (RBM), deep belief network (DBN), bi-directional network, bi-directional recurrent deep neural network (BRDNN), generative adversarial network (GAN), transformer-based networks, deep Q-network, large language models etc.

A learning algorithm is a method of training a predetermined target device or target function based on a corresponding plurality of training data that causes, enables, controls, or provides an output of the target device or target function. Examples of learning algorithms include, but not limited to, supervised learning, unsupervised learning, semi-supervised learning or reinforcement learning, and so on.

A person skilled in the art will appreciate that the various illustrative logical blocks (functional blocks or modules) and steps (operations) used in the embodiments of the disclosed technical solution may be implemented by electronic hardware, computer software, or a combination thereof. Whether the functions are implemented by using hardware or software depends on particular applications and requirements to a design of an entire system. A person skilled in the art may use different methods to implement the described functions for each particular application, but it should not be considered that such an implementation will go beyond the scope of the embodiments disclosed in the application.

It should also be noted that the order of steps of any disclosed method is not strict, because some one or more steps may be rearranged in the actual order of execution and/or combined with another one or more steps, and/or divided into a larger number of sub-steps.

Throughout this application, reference to an element in the singular form does not preclude the presence of a plurality of such elements in the actual implementation of the disclosure, and, conversely, reference to an element in the plural form does not exclude the presence of only one such element in the actual implementation of the disclosure. Any specific value or a range of values specified above should not be interpreted in a limiting sense, but rather such a specific value or a range of values should be considered to represent the midpoint of the specified larger range, up to approximately 50% on either side of the specified value or specified boundaries of a smaller range.

While this disclosure has been made and described with reference to specific disclosure embodiments and examples thereof, those skilled in the art will understand that various changes in form and content may be made without departing from the spirit and scope of this disclosure as defined by the appended claims and their equivalents. In other words, the foregoing detailed description is based on specific examples and possible implementations of the present disclosure, but should not be interpreted to mean that only the explicitly disclosed implementations are feasible. It is intended that any change or substitution that could be made to this disclosure by one of ordinary skill in the art without creative and/or technical contribution shall be within the scope of protection (with equivalents considered) provided by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
identifying at least one reference signal associated with a first radio access technology (RAT);
identifying at least one reference signal associated with a second RAT;
generating at least one common reference signal; and
transmitting, to a terminal, the at least one common reference signal,
wherein the at least one common reference signal is used by both the first RAT and the second RAT and is transmitted in a time-frequency resource shared by the first RAT and the second RAT.

2. The method of claim 1, wherein the at least one common reference signal comprises at least one of a primary synchronization signal (PSS), a secondary synchronization signal (SSS),
wherein a transmission of a physical broadcast channel (PBCH) of the first RAT and a transmission of a PBCH of the second RAT are performed using non-overlapping subcarriers and/or non-overlapping OFDM symbols,
wherein, in case that only the PSS is the common reference signal, a transmission of an SSS of the first RAT and a transmission of an SSS of the second RAT are performed using same subcarriers but different orthogonal frequency division multiplexing (OFDM) symbols, and
wherein, in case that only the SSS is the common reference signal, a transmission of a PSS of the first RAT and a transmission of a PSS of the second RAT are performed using the same subcarriers but different OFDM symbols.

3. The method of claim 1, further comprising:
transmitting, to the terminal, information comprising at least one of different cyclic shifts, or different roots,
wherein the at least one of different cyclic shifts, or different roots is applied to a zadoff-chu (ZC) sequence to generate different physical random access channel (PRACH) preambles associated with the first RAT or the second RAT, and
wherein the different PRACH preambles are received using the time-frequency resource shared by the first RAT and the second RAT.

4. The method of claim 1, wherein the at least one common reference signal comprises a channel state information reference signal (CSI-RS), and
wherein the first RAT is 5th generation (5G) and the second RAT is 6th generation (6G).

5. A method performed by a terminal in a wireless communication system, the method comprising:
receiving, from a base station, at least one reference signal associated with a first radio access technology (RAT) or a second RAT; and
receiving, from the base station, at least one common reference signal,
wherein the at least one common reference signal is used by both the first RAT and the second RAT and is received in a time-frequency resource shared by the first RAT and the second RAT.

6. The method of claim 5, wherein the at least one common reference signal comprises at least one of a primary synchronization signal (PSS), a secondary synchronization signal (SSS),
wherein a transmission of a physical broadcast channel (PBCH) of the first RAT and a transmission of a PBCH of the second RAT are performed by the base station using non-overlapping subcarriers and/or non-overlapping OFDM symbols,
wherein, in case that only the PSS is the common reference signal, a transmission of an SSS of the first RAT and a transmission of an SSS of the second RAT are performed by the base station using same subcarriers but different orthogonal frequency division multiplexing (OFDM) symbols, and
wherein, in case that only the SSS is the common reference signal, a transmission of a PSS of the first RAT and a transmission of a PSS of the second RAT are performed by the base station using the same subcarriers but different OFDM symbols.

7. The method of claim 5, further comprising:
receiving, from the base station, information comprising at least one of different cyclic shifts, or different roots,
wherein the at least one of different cyclic shifts, or different roots is applied to a zadoff-chu (ZC) sequence to generate different physical random access channel (PRACH) preambles associated with the first RAT or the second RAT,
wherein the at least one common reference signal comprises a channel state information reference signal (CSI-RS), and
wherein the first RAT is 5th generation (5G) and the second RAT is 6th generation (6G).

8. A base station in a wireless communication system, the base station comprising:
a transceiver; and
at least one processor coupled with the transceiver and configured to:
identify at least one reference signal associated with a first radio access technology (RAT),
identify at least one reference signal associated with a second RAT,
generate at least one common reference signal, and
transmit, to a terminal, the at least one common reference signal,
wherein the at least one common reference signal is used by both the first RAT and the second RAT and is transmitted in a time-frequency resource shared by the first RAT and the second RAT.

9. The base station of claim 8, wherein the at least one common reference signal comprises at least one of a primary synchronization signal (PSS), a secondary synchronization signal (SSS),
wherein a transmission of a physical broadcast channel (PBCH) of the first RAT and a transmission of a PBCH of the second RAT are performed using non-overlapping subcarriers and/or non-overlapping OFDM symbols,
wherein, in case that only the PSS is the common reference signal, a transmission of an SSS of the first RAT and a transmission of an SSS of the second RAT are performed using same subcarriers but different orthogonal frequency division multiplexing (OFDM) symbols, and
wherein, in case that only the SSS is the common reference signal, a transmission of a PSS of the first RAT and a transmission of a PSS of the second RAT are performed using the same subcarriers but different OFDM symbols.

10. The base station of claim 8, wherein the at least one processor is further configured to:
transmit, to the terminal, information comprising at least one of different cyclic shifts, or different roots,
wherein the at least one of different cyclic shifts, or different roots is applied to a zadoff-chu (ZC) sequence to generate different physical random access channel (PRACH) preambles associated with the first RAT or the second RAT, and
wherein the different PRACH preambles are received using the time-frequency resource shared by the first RAT and the second RAT.

11. The base station of claim 8, wherein the at least one common reference signal comprises a channel state information reference signal (CSI-RS), and
wherein the first RAT is 5th generation (5G) and the second RAT is 6th generation (6G).

12. A terminal in a wireless communication system, the terminal comprising:
a transceiver; and
at least one processor coupled with the transceiver and configured to:
receive, from a base station, at least one reference signal associated with a first radio access technology (RAT) or a second RAT, and
receive, from the base station, at least one common reference signal,
wherein the at least one common reference signal is used by both the first RAT and the second RAT and is received in a time-frequency resource shared by the first RAT and the second RAT.

13. The terminal of claim 12, wherein the at least one common reference signal comprises at least one of a primary synchronization signal (PSS), a secondary synchronization signal (SSS),
wherein a transmission of a physical broadcast channel (PBCH) of the first RAT and a transmission of a PBCH of the second RAT are performed by the base station using non-overlapping subcarriers and/or non-overlapping OFDM symbols,
wherein, in case that only the PSS is the common reference signal, a transmission of an SSS of the first RAT and a transmission of an SSS of the second RAT are performed by the base station using same subcarriers but different orthogonal frequency division multiplexing (OFDM) symbols, and
wherein, in case that only the SSS is the common reference signal, a transmission of a PSS of the first RAT and a transmission of a PSS of the second RAT are performed by the base station using the same subcarriers but different OFDM symbols.

14. The terminal of claim 12, wherein the at least one processor is further configured to:
receive, from the base station, information comprising at least one of different cyclic shifts, or different roots, and
wherein the at least one of different cyclic shifts, or different roots is applied to a zadoff-chu (ZC) sequence to generate different physical random access channel (PRACH) preambles associated with the first RAT or the second RAT.

15. The terminal of claim 12, wherein the at least one common reference signal comprises a channel state information reference signal (CSI-RS), and
wherein the first RAT is 5th generation (5G) and the second RAT is 6th generation (6G).
